(19) United States
(12) Patent Application Publication
(10) Pub. No.: US 2007/0210195 A1
(43) Pub. Date: Sep. 13, 2007

(54) Handheld Grinding Mill

(76) Inventors: Dean Chapman, Montclair, NJ (US); Paul Goetz, New York, NY (US); Ed Kilduff, New York, NY (US); Gareth Brown, Jersey City, NJ (US)

Correspondence Address: WHITE-WELKER & WELKER, LLC, P.O. BOX 199, CLEAR SPRING, MD, 21722-0199, US

(21) Appl. No.: 11/685,323

(22) Filed: Mar. 13, 2007

Related U.S. Application Data
(60) Provisional application No. 60/782,142, filed on Mar. 13, 2006.

(51) Int. Cl. A47J 42/00

(52) U.S. Cl. 241/169.1

(57) ABSTRACT

The present invention is a handheld grinding mill. The handheld grinding mill of the present invention is operated by first removing the grinder knob and screw off cap to expose the interior chamber of the body, where the desired spice would be place for grinding. Once the body is loaded with the desired spice, the cap and knob are attached. To open and close the aperture, the shutter-actuating ring is rotated either clockwise or counter clockwise, placing the doors in either a closed or open position, as desired. To grind and dispense spices loaded in the body of the mill, the actuating ring is rotated to retract the doors and open the aperture and the knob is rotated, which results in a rotation of the grinder and dispensing of the spice through the aperture.

### CROSS REFERENCE TO RELATED APPLICATIONS

This application claims priority from U.S. Provisional Patent Application Ser. No. 60/782,142, entitled “Handheld Grinding Mill”, filed on Mar. 13, 2006.

### TECHNICAL FIELD OF THE INVENTION

The present invention relates generally to handheld kitchen tools. More specifically, the present invention relates to handheld grinding mills for use in commercial and residential kitchens and food preparation that enables convenient grinding of peppercorns, spices, coffee beans or the like or other in the grinding mill while providing a watertight seal for easy cleaning.

### BACKGROUND OF THE INVENTION

Pepper and salt are two most popular condiments that are usually available together on the table or used in food preparation, especially for meat dishes. Pepper often needs grinding from pepper seeds at the time of serving for freshness. Pepper grinders may be designed to contain and dispense salt as well, as is already known in the art. The prior art also teaches many various designs of pepper grinders, most of which focus on the manner of use, such as one handed use, offering a grinder that may be rotated in a clockwise or counterclockwise manner, or providing for adjustable grinding sizes.

Conventional grinders known in the prior art consist primarily of the following components in combination: a base containing a grinding member, a container body attached to the base 10, and a cover on top of the container body. In use, the cover is removed from the container body, and then grain material to be ground is placed in the container body. Next, the cover is replaced on the container body and the base is held in a fixed position while the container body rotates so that the grain material in contact with the grinding member can be ground into powder and dispensed out of a lower end of the base for use in cooking or seasoning.

However, such conventional grinders are not designed to come in contact with the food product being seasoned and are not designed for repeated, frequent, or daily cleaning with the removable of the grain contained within the body.

The prior art does not address the use of a grinder in specific preparation with meat or fish products, where contact between the grinder and food product could result in food contamination, or without daily or frequent cleaning, could result in the growth of bacteria resulting in contamination to the food products being seasoned as well as other food products located in the area of same location.

Therefore, it is an objective of the present invention to teach a grinding mill that has a sealed aperture for dispensing the grindings that can be easily opened during grinding and closed with a watertight seal for cleaning.

### SUMMARY OF THE INVENTION

The handheld grinding mill of the present invention is operated by first removing the grinder knob and screw off cap to expose the interior chamber of the body, where the desired spice would be place for grinding. Once the body is loaded with the desired spice, the cap and knob are attached. To open and close the aperture, the shutter-actuating ring is rotated either clockwise or counter clockwise, placing the doors in either a closed or open position, as desired. To grind and dispense spices loaded in the body of the mill, the actuating ring is rotated to retract the doors and open the aperture and the knob is rotated, which results in a rotation of the grinder and dispensing of the spice through the aperture.

The primary advantage of the present invention is that it provides a grinding that comprised of a water tight body for storing the spice the allows for quick and easy dispensing and frequent cleaning, while eliminating the need to unload and reload the spice between cleaning or during storage.

The use of two shutters and a shutter-actuating ring enable the device to function in the same manner as other grinders known in the prior art while also providing a sealed closure means for the dispensing aperture.

Another advantage of the present invention is the sealed closure means for the dispensing aperture enables one to store the spice contained within the body in an air tight manner, which provides for longer storage time and more freshness.

Yet another advantage of the present invention is the cleaning advantage provided by the sealed closure means for the dispensing aperture. By teaching the sealing means, the present invention allows for use of a grinding mill in a commercial where it may used on or come in contact with many meats and fish, where such contact may lead to repeated cleaning or the contamination of food. The sealing feature enables a user to quickly close and clean the device without the need to remove the contents of the body or risk exposing the contents to cleaning agents or water.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the exterior appearance of the grinder of the present invention;

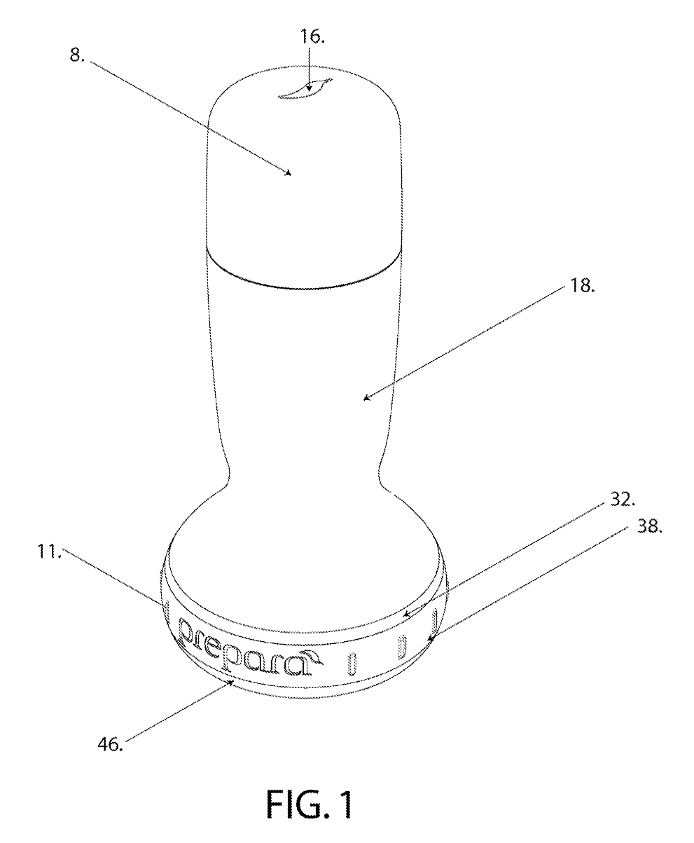

FIG. 2 illustrates the exterior appearance of the grinder of the present invention with the sealing cap top removed;

FIG. 3 is a cross sectional view which illustrates the internal grinding and shutter mechanisms of the present invention;

FIG. 4 is a first expanded view of the grinder, illustrating all physical components;

FIG. 5 is a second expanded view of the grinder, illustrating all physical components; and

FIG. 6 illustrates the interior components of an assembled grinding mechanism.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

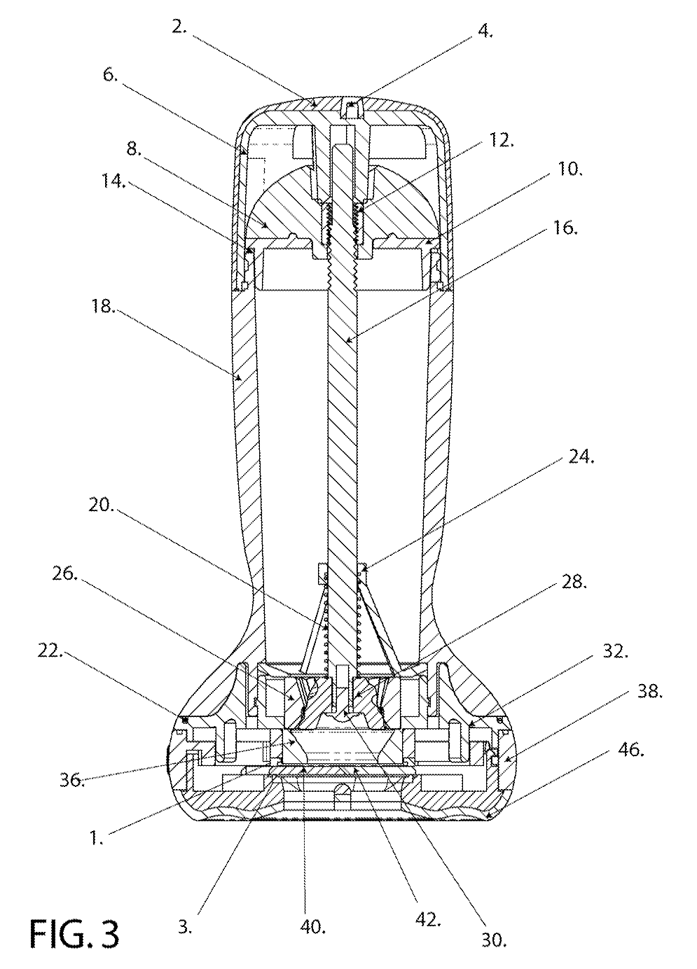

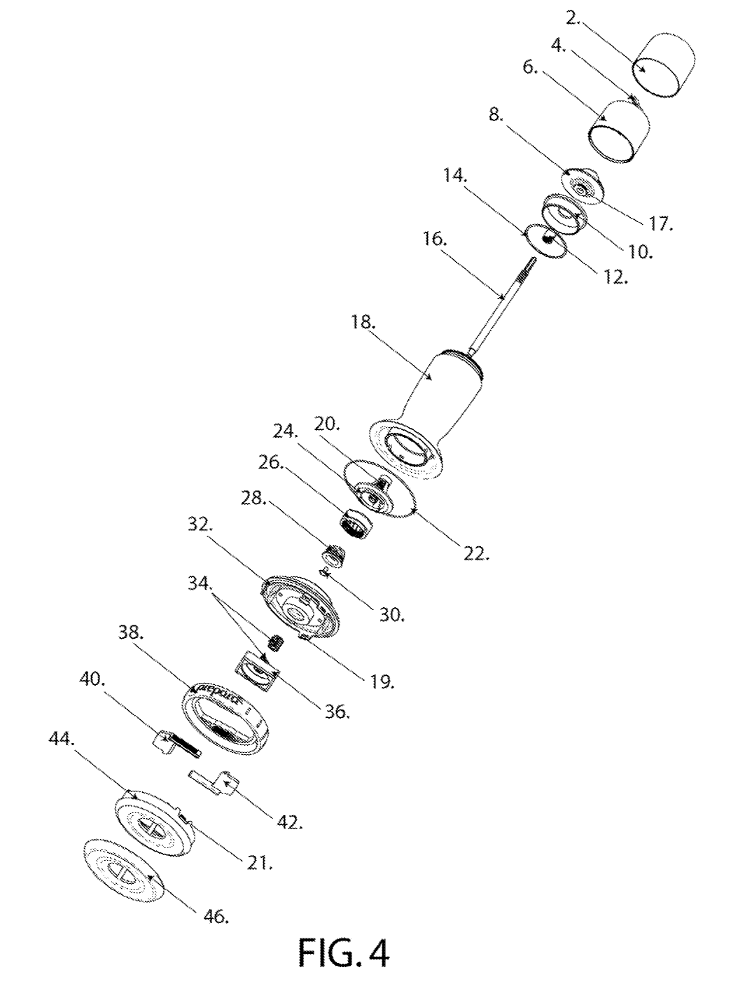

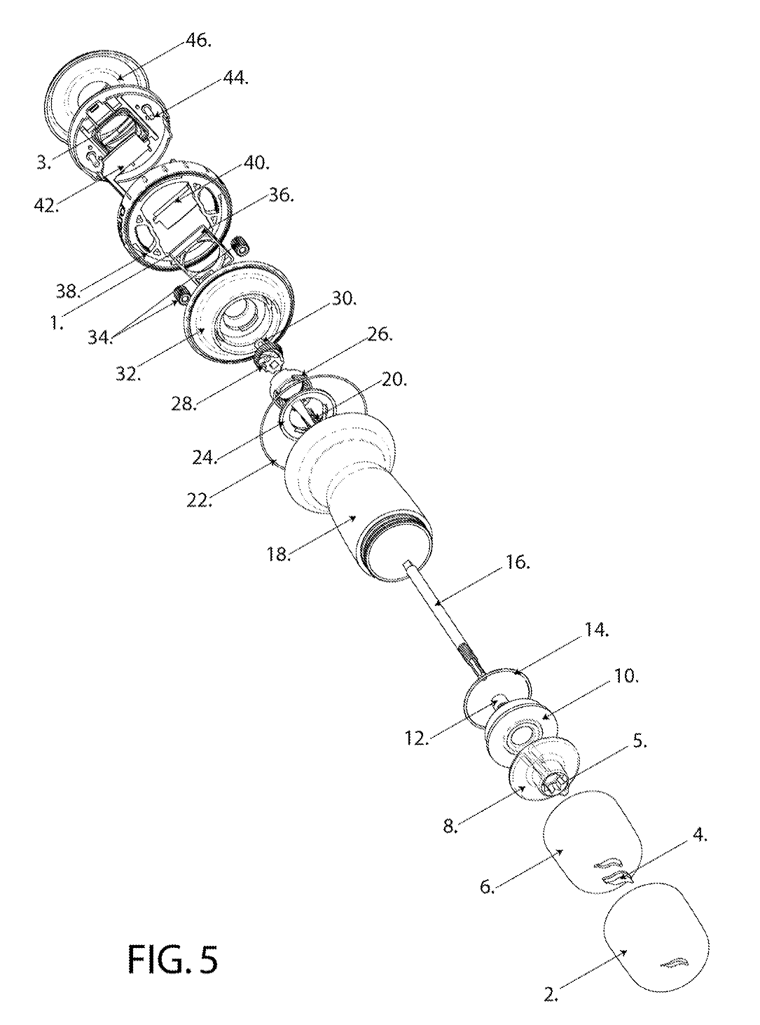

Referring to the figures, it is possible to see the various major elements constituting the apparatus of the present invention. The present invention is a handheld grinding mill. Now referring to FIGS. 3, 4, and 5, the physical components of the present invention are illustrated in expanded views, FIGS. 4 and 5, and cross sectional view, FIGS. 3, which illustrate the internal mechanisms of the grinder mill of the present invention. As illustrated, the grinder mill comprises: a main body 18 attached on one end to a bottom cover 44 and bottom cover TPE 46 and on the other opposing end to a top cap 6 and top cap TPE 2. The top cap 6 is attached to the top cap TPE 2 so that the molded leaf logo 4 is visible. A sealing cap top 8 engages a sealing cap bottom 10 using a sealing cap securing clip 17 as means for locking the cap top 8 and cap bottom 10 together. Because of this attachment these two parts can rotate freely relative to each other. The combined sealing cap top 8 and sealing cap bottom 10 are pressed into the main body 18 using a top o-ring 14 to secure a liquid and air proof seal. The sealing cap top 8 is threaded onto one end of the central axle 16 using a threaded brass insert 12 and is actuated by a shaft actuator 5 within the cap top 8.

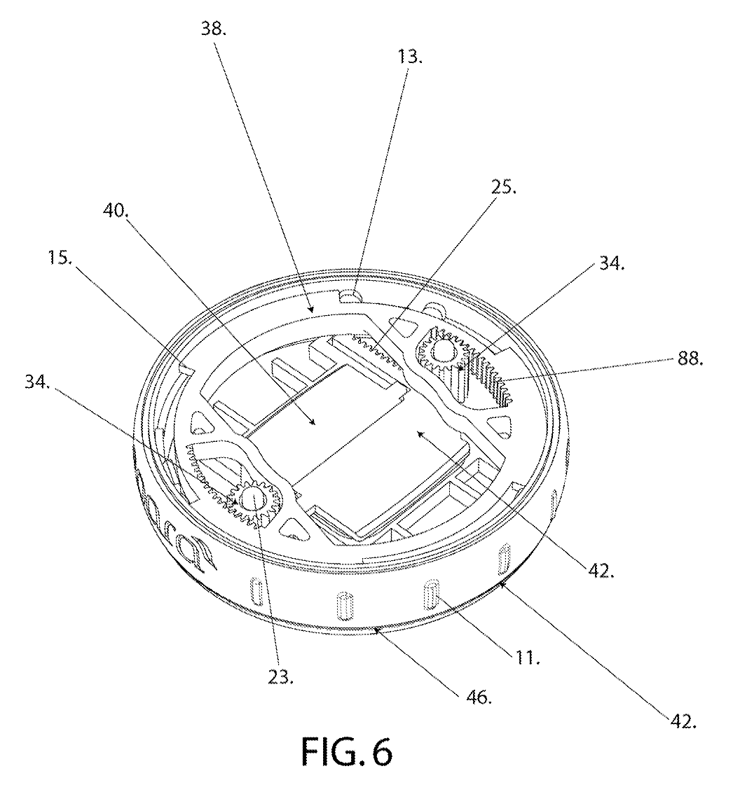

The opposing end of the central axle 16 is connected to the grinder spring 20 and spring holder 24 to which a grinder plate top 26 and a grinder plate bottom 28 are attached via a grinder plate securing nut 30. The decorative ring 32 is attached to the main body 18 with a lower o-ring 22 providing sealing means. The bottom cover 44 provides means for containing and storing a first door 40 and a second door 42 which when moved open and close the dispensing aperture. The actuator ring 38 engages the bottom cover 44 and the first door 40 and the second door 42 are secured there between and manipulated in position by the door actuator ring gears 34 and sealing block 36. The actuator ring 38 and its interior components are secured in place by the bottom cover 44 which is comprised of lower locking spring fingers 21 that engage the lower locking tab of the actuator ring 38 thereby securing the decorative ring 38 and all internal components as illustrated in FIG. 6, in position.

Now referring to FIG. 6, the actuator ring 38 and inner components are show in more detail. The actuator ring 38 rest upon the bottom cover 44, which is covered on its external surface by the bottom cover TPE 46. The actuator ring 38 is covered on its external surfaces by opening ring thumb grips 11 which are used to rotate the actuator ring in a clockwise or counterclockwise rotation with respect the main body 8 to open and close the doors. The actuator ring 38 is further comprised of a tooth portion 88 and linear door gear 25 that is engaged by the actuator ring gears 34 which are supported by and rotate on the gear posts 23 of the actuator ring 38 to open and close the first door 40 and second door 42.

An airtight seal around the door is accomplished by the use of a top rubber door seal 1 and a bottom rubber door seal 3 as show in FIG. 3.

The actuator ring 38 may also consist of a bottom cover stop tab 13 that limits rotation of the actuator rings 38 and an actuator ring guide slot 15 that interacts with bottom cover stop tab 13 to limit rotation both actions which would result in over rotation and possible damage to the device.

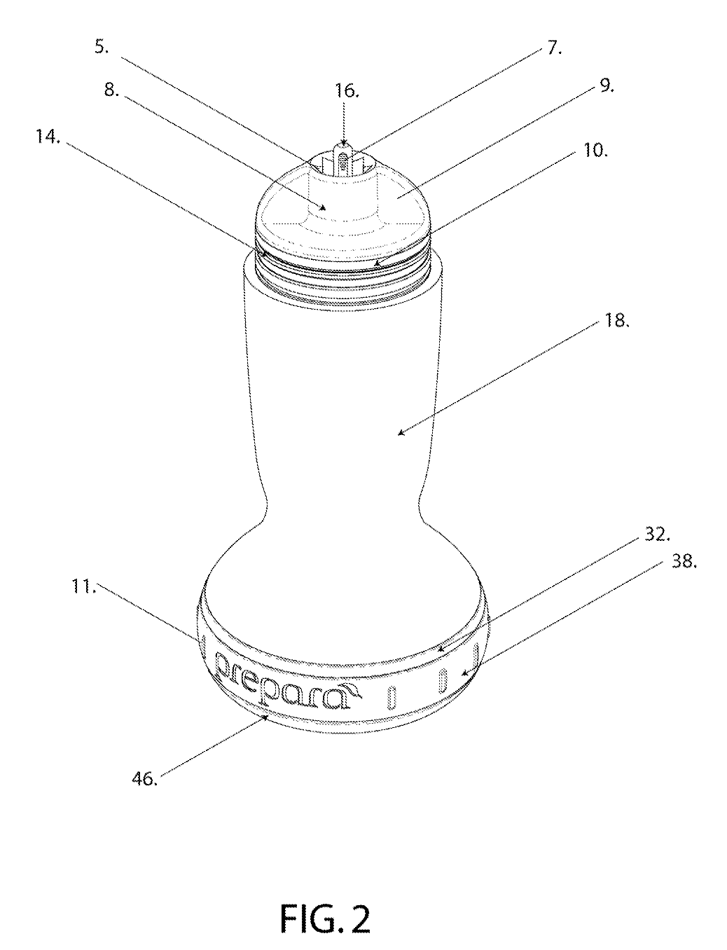

Now referring to FIG. 2, the grinder device is shown with the top cap 6 and top cap TPE 2 removed exposing the sealing cap top 8 which is further comprised of a thumb screw grip 9 and fineness gauge 7 for adjusting the grinding size by rotating the sealing cap 8 top either clockwise for a finer grind or counter-clockwise for a coarser grind. This in turn pulls the central axle 16 up or down, compressing or extending the grinder spring 20 and changing the distance between the grinder plate top 26 and grinder plate bottom 28.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A handheld grinding mill comprising:
a main body for holding material to be ground;
a bottom cover;
a bottom cover TPE;
a top cap engaged with a central axle;
a top cap TPE;
a sealing cap top;
a sealing cap bottom;
a sealing cap securing clip as means for locking said cap top and cap bottom together;
the combined sealing cap top and sealing cap bottom pressed into the main body using a top o-ring;
said sealing cap top is threaded onto one end of a central axle using a threaded brass insert and is actuated by a shaft actuator within the cap top;
the opposing end of the central axle is connected to a grinder spring and a spring holder to which a grinder plate top and a grinder plate bottom are attached via a grinder plate securing nut;
rotation of the top cap is transmitted to grinder plate top and a grinder plate bottom;
a decorative ring attached to the main body with a lower o-ring;
a bottom cover providing means for containing and storing a first door and a second door;
an actuator ring providing means for engaging the bottom cover; said first door and the second door are secured to the actuator ring by door actuator rings and a sealing block;
said actuator ring is secured in place by the bottom cover which is further comprised of
lower locking spring fingers that engage a lower locking tab of the actuator ring thereby securing the decorative ring and all internal components in position; and
rotation of the actuator ring is transmitted to the first door and the second door.

2. The handheld grinding mill of claim 1 wherein the top cap is attached to the top cap TPE so that a molded logo protruding from the top cap is visible.

3. The handheld grinding mill of claim 1 wherein
the actuator ring rests upon the bottom cover;
said bottom cover is covered on its external surface by a bottom cover TPE;
said actuator ring is covered on its external surfaces by a ring of thumb grips which are used to rotate the actuator ring in a clockwise or counterclockwise rotation with respect the main body to open and close the first and second doors; and
the actuator ring is further comprised of a tooth portion and a linear door gear that is engaged by actuator ring gears which are supported by and rotate on gear posts of the actuator ring to open and close the first door and second door.

4. The handheld grinding mill of claim 1 further comprising a top rubber door seal and a bottom rubber door seal around the first door and the second door.

5. The handheld grinding mill of claim 1 wherein actuator ring further consists of
a bottom cover stop tab that limits rotation of the actuator rings gears; and
an actuator ring guide slot that interacts with a bottom cover stop tab to limit rotation.

6. The handheld grinding mill of claim 1 wherein the sealing cap top is further comprised of a thumb screw grip and fineness gauge 7 for adjusting grinding size.

7. The handheld grinding mill of claim 1 wherein rotating the sealing cap top either clockwise or counter clockwise provides means for a grind size adjustment.

8. The handheld grinding mill of claim 7 wherein
rotating the sealing cap top clockwise provides means for a finer grind; and
rotating the sealing cap top counter-clockwise provides means for a coarser grind.

9. The handheld grinding mill of claim 8 wherein
rotating the sealing cap top clockwise pulls the central axle up compressing the grinder spring and reducing the distance between the grinder plate top and grinder plate bottom; and
rotating the sealing cap top counter-clockwise pushes the central axle down extending the grinder spring and increasing the distance between the grinder plate top and grinder plate bottom.
